(19) United States
(12) Patent Application Publication
(10) Pub. No.: US 2026/0230850 A1
(43) Pub. Date: Aug. 6, 2026

(54) ADAPTING BEAM PREDICTION NEURAL NETWORK MODELS

(71) Applicant: Lenovo (United States) Inc., Morrisville, NC (US)

(72) Inventor: Venkata Srinivas Kothapalli, Morrisville, NC (US)

(21) Appl. No.: 19/047,270

(22) Filed: Feb. 6, 2025

(51) Int. Cl. H04W 24/02; G06N 3/09

(52) U.S. Cl. CPC H04W 24/02; G06N 3/09

(57) ABSTRACT

Various aspects of the present disclosure relate to adapting a beam selection neural network (NN), such as a beam prediction deep neural network (DNN), to perform predictions for unseen or unknown target domains, such as by using unlabeled data samples from the target domains. For example, the beam prediction DNN may include normalization layers between neural layers of the DNN. Further, the adaptation of the DNN may be based on an adaptation of the normalization layers (e.g., adapting affine parameters of LN layers without labeled data samples), and not the entire DNN.

### TECHNICAL FIELD

The present disclosure relates to wireless communications, and more specifically to the adaptation of beam prediction neural network (NN) models.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In order for a UE to connect to a base station, the UE or the base station or both may perform beam search or beam selection. Beam selection involves the selection of a beam at a base station and a corresponding beam at a UE, where the UE selects a beam-pair (e.g., the beam at the base station and the beam at the UE) that results in a high signal strength for communication between the devices.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to adapt beam prediction NN models for beam selection procedures at specific cell sites.

A first node for wireless communication is described. The first node may be configured to, capable of, or operable to perform one or more operations as described herein. For example, the first node may comprise at least one memory and at least one processor coupled with the at least one memory and configured to cause the first node to determine an NN model for beam prediction, by computing a set of NN parameters associated with multiple neural layers of the NN model and computing a set of affine parameters associated with at least one layer normalization (LN) layer of the NN model, and transmit, to a second node, a set of model parameters that includes the set of NN parameters and the set of affine parameters.

A method performed or performable by the first node is described. The method may comprise determining an NN model for beam prediction, by computing a set of NN parameters associated with multiple neural layers of the NN model and computing a set of affine parameters associated with at least one LN layer of the NN model, and transmitting, to a second node, a set of model parameters that includes the set of NN parameters and the set of affine parameters.

In some implementations of the first node and method described herein, the set of affine parameters includes a set of scale parameters and a set of shift parameters for the at least one LN layer.

In some implementations of the first node and method described herein, the NN model is based on a set of data samples that includes unlabeled data samples, labeled data samples, or a combination of unlabeled data samples and labeled data samples.

In some implementations of the first node and method described herein, the first node and method may further be configured to, capable of, performed, performable, or operable to determine the set of data samples.

In some implementations of the first node and method described herein, the first node and method may further be configured to, capable of, performed, performable, or operable to receive the set of data samples from another node.

In some implementations of the first node and method described herein, the first node and method may further be configured to, capable of, performed, performable, or operable to determine the NN model for beam prediction by computing a global set of parameters, which includes the set of NN parameters and the set of affine parameters, via a learning algorithm that is based on the set of data samples.

A second for wireless communication is described. The second node may be configured to, capable of, or operable to perform one or more operations as described herein. For example, the second node may comprise at least one memory and at least one processor coupled with the at least one memory and configured to cause the second node to determine whether to update an NN model for beam prediction, wherein the NN model for beam prediction includes multiple neural layers, at least one layer LN layer, and a set of affine parameters associated with at least one LN layer, and update the set of affine parameters based on a set of input data samples.

A method performed or performable by the second node is described. The method may comprise determining whether to update an NN model for beam prediction, wherein the NN model for beam prediction includes multiple neural layers, at least one layer LN layer, and a set of affine parameters associated with at least one LN layer and updating the set of affine parameters based on a set of input data samples.

In some implementations of the second node and method described herein, the second node and method may further be configured to, capable of, performed, performable, or operable to determine the set of input data samples.

In some implementations of the second node and method described herein, the second node and method may further be configured to, capable of, performed, performable, or operable to receive the set of data samples from another node.

In some implementations of the second node and method described herein, the second node and method may further be configured to, capable of, performed, performable, or operable to update the set of affine parameters by determining a first quantity associated with a measure of uncertainty in an output of the NN model resulting from the set of input data samples, determining a second quantity associated with a remaining uncertainty in the output of the NN model resulting from the set of input data samples, determining a weighted first quantity for the first quantity and a weighted second quantity for the second quantity, and determining the set of affine parameters by minimizing a difference between the second weighted quantity and the first weighted quantity.

In some implementations of the second node and method described herein, the measure of uncertainty in the output of the NN model is a measure of entropy of the output.

In some implementations of the second node and method described herein, the measure of remaining uncertainty in the output of the NN model is a measure of conditional entropy in the output.

In some implementations of the second node and method described herein, the weighted first quantity and the weighted second quantity are based on weights having values between 0 and 1, inclusive.

In some implementations of the second node and method described herein, the second node and method may further be configured to, capable of, performed, performable, or operable to determine to update the NN model based on information that indicates periodic time intervals for updating the NN model.

In some implementations of the second node and method described herein, the second node and method may further be configured to, capable of, performed, performable, or operable to determine to update the NN model based on receiving an indication to update the NN model from a first node.

In some implementations of the second node and method described herein, the second node and method may further be configured to, capable of, performed, performable, or operable to determine to update the NN model based on receiving a configuration associated with updating the NN model from a first node.

In some implementations of the second node and method described herein, the second node and method may further be configured to, capable of, performed, performable, or operable to determine to update the NN model based on information that indicates certain conditions of a communications network that includes the second node.

In some implementations of the second node and method described herein, the second node and method may further be configured to, capable of, performed, performable, or operable to determine to update the NN model based on determining a quality metric for a functionality of the NN model.

### BRIEF DESCRIPTION OF THE DRAWINGS

FIG. 1 illustrates an example of a wireless communications system in accordance with aspects of the present disclosure.

FIG. 2 illustrates example communications between a first node and a second node in accordance with aspects of the present disclosure.

FIG. 3 illustrates an example beam prediction NN in accordance with aspects of the present disclosure.

FIG. 4 illustrates a flowchart of a method for adapting a beam prediction NN in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of a network equipment (NE) in accordance with aspects of the present disclosure.

FIG. 8 illustrates a flowchart of a method performed by an NE in accordance with aspects of the present disclosure.

FIG. 9 illustrates a flowchart of a method performed by a UE in accordance with aspects of the present disclosure.

### DETAILED DESCRIPTION

Beam selection often involves the selection of an optimal beam (e.g., a beam offering a maximum signal strength) across all available beams. For example, a UE may perform an exhaustive search procedure, where a base station sends a reference signal on a subset of or all transmitting (Tx) beams, and the UE measures the signal strength (e.g., the reference signal received power (RSRP), the signal to interference plus noise ratio (SINR), and so on). The UE may then report the beam (e.g., via a beam index) with the highest signal strength to the base station. Such a procedure, while useful for beam selection, may introduce problems associated with high overhead and latency, especially for base stations having large antenna arrays that support many beams (e.g., base stations using millimeter wave (mmWave) frequencies).

To mitigate such problems, wireless communications systems may employ artificial intelligence (AI) and/or machine learning (ML) techniques, such as deep learning, to perform beam selection by predicting the beam having the highest signal strength. Beam prediction enhances or improves beam selection by employing and training (e.g., using supervised learning) a NN (e.g., a deep neural network, or DNN) to determine an optimal beam index for a cell site (e.g., at a base station). For example, the DNN performs measurements of a subset of beams for a cell site and outputs a mapping between the beam measurements and a best beam index.

While such beam prediction techniques are useful for targeted, known, or generalized scenarios, they may provide suboptimal predictions when deployed in unique or unknown scenarios, such as in scenarios where the data input into the DNN has different or unique statistical characteristics that the data from which the DNN or AI/ML model was trained. For example, beam prediction models are often specifically adapted to a certain cell site and trained on the physical characteristics of the cell site.

However, when deployed to a different cell site, data samples

$$( e . g . , {𝒟}^{t} = {\{ ( {x}_{i}^{t} , {y}_{i}^{t} ) \}}_{i = 1}^{N} ∼ {P}_{X Y}^{t} )$$

that are inputted into the model may be different from the data samples

$$( e . g . , {𝒟}^{s} = {\{ ( {x}_{i}^{s} , {y}_{i}^{s} ) \}}_{i = 1}^{{N}_{t r}} ∼ {P}_{X Y}^{s} )$$

used to train the model

$$( e . g . , the {P}_{X Y}^{s} is different than {P}_{X Y}^{t} ) .$$

Thus, a distribution of beam measurements, (S₀, S₁, . . . , S_{M′-1}), which are the distribution P(x) of the input samples to the model, may be vulnerable to differences or variations. Further, a mapping between the beam measurements and a corresponding optimal beam may change based on physical characteristics of the propagation medium (e.g., between outdoor scenarios and indoor scenarios), and P(y|x), a distribution of the output conditioned on the input, may change for beam selection.

The systems and methods described herein adapt a beam selection NN (e.g., a beam prediction NN), such as a DNN, to perform predictions for unseen or unknown target domains, such as by using unlabeled data samples from the target domains. For example, the DNN may include normalization layers between neural layers of the DNN. Further, the adaptation of the DNN may be an adaptation of the normalization layer (e.g., adapting affine parameters of LN layers without labeled data samples), and not the entire DNN.

In doing so, the systems and methods can utilize a DNN (or other AI/ML models) to perform beam prediction for a base station or cell site that is specific to the characteristics of the base station or cell site, taking advantage of employing beam prediction as a beam selection technique while mitigating issues with latency, overhead, and prediction errors, among other benefits.

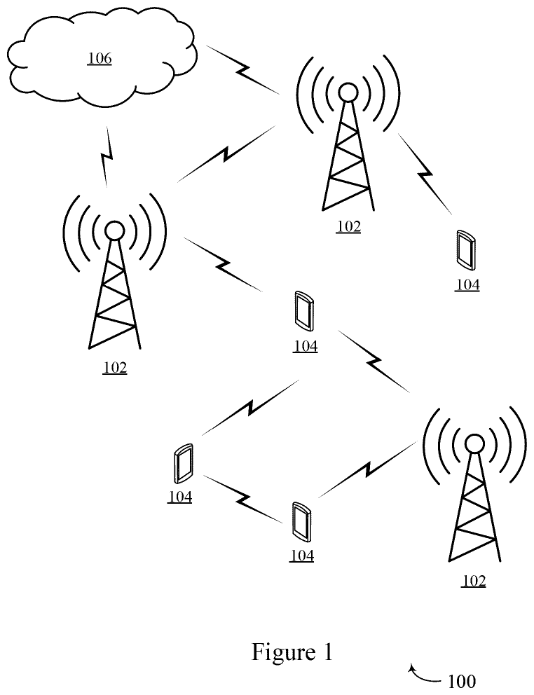

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a DNN is enhanced to include LN layers between neural layers (e.g., an LN between every two neural layers), which facilitates the adaptation of the DNN when deployed at a specific cell site (e.g., such as a gNB). Thus, in some embodiments, the DNN may be adapted by only adapting the LN layers (e.g., affine parameters of the LN layers based on unlabeled data samples), and not the other layers or parameters of the DNN.

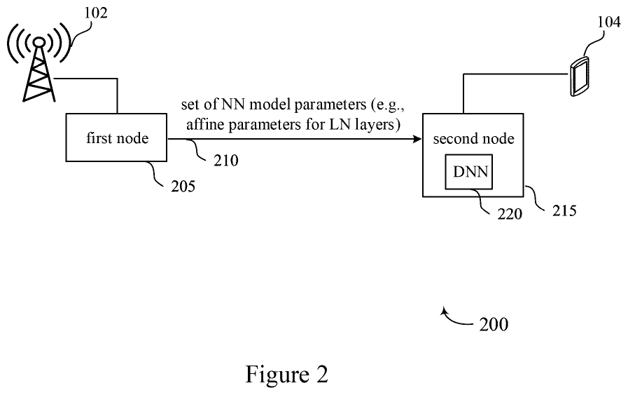

FIG. 2 illustrates example communications 200 between a first node 205 and a second node 215 in accordance with aspects of the present disclosure. The first node 205 (e.g., an encoder) may be associated with the NE 102 (e.g., may be the NE 102, such as a gNB) and the second node 215 (e.g., a decoder) may be associated with the UE 104 (e.g., may be the UE 104). While shown as being associated with the NE 102, the first node 205, in some cases, may be part of or otherwise associated with the UE 104, and, similarly, the second node 215 may be part of otherwise associated with the NE 102.

The UE 104 may initiate a beam selection or beam prediction procedure to connect to the NE 102. Before doing so, the UE 104, acting as the second node 215, may receive a set of NN model parameters 210 transmitted from the NE 102, acting as the first node 205. For example, the set of NN model parameters 210 may include a set of NN parameters for neural layers and a set of affine parameters for one or more LN layers of a DNN 220 that is employed by the UE 104 when performing beam prediction. The UE 104 may adapt the DNN 220 with the received affine parameters to tailor or modify the DNN 220 to the specific NE 102. Using the adapted DNN 220, the UE 104 performs beam prediction, and selects a suitable or optimal beam for connection to the NE 102.

The set of NN parameters for the neural layers may include weights of edges of the NN, as well as other information, parameters, and/or details about the architecture and/or configuration of the DNN 220. For example, the DNN 220 may be categorized, defined, and/or specified (uniquely), by some or all of the following information or parameters (e.g., the set of NN parameters): a number of layers L, a number of neurons in each layer [symbol] , for [symbol] =1, . . . , L, activation functions of the neurons, connectivity between the neurons belonging to successive layers (e.g., whether the edge (i, j) exists for the i^{th} neuron in layer [symbol] (for [symbol] =2, . . . , L, i=1 . . . , n [symbol] ), and the j^{th} neuron in layer [symbol] −1 (for [symbol] =2, . . . , L, j=1 . . . , n [symbol] ₋₁)), weights of all the edges between neurons belonging to every successive pair of layers:

$$W = \{ {w}_{i j}^{( ℓ )} \} ,$$

[symbol]

=1, . . . , L, i=1, . . . , n [symbol] , j=1, . . . , [symbol] ₋₁, and so on.

As described herein, the DNN 220 may be a beam prediction NN, or f_{θ}, which includes LN layers. The DNN 220 may be based on training data from one or more source data domains, where θ={θ₁, θ₂, . . . , θ_{N}} (e.g., a set of all learnable/trainable parameters/weights, or N parameters, of the NN. The DNN 220 may include one or more LN layers, which operate to adapt or change a statistical distribution of data samples received from a preceding layer, before feeding the adapted/changed data samples as inputs to a subsequent layer.

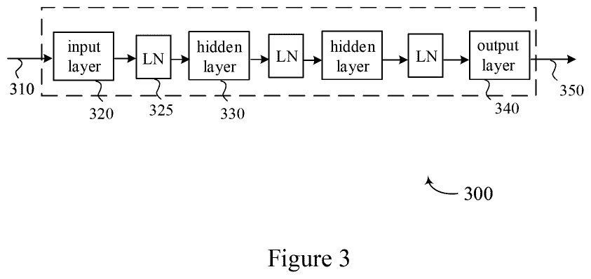

FIG. 3 illustrates an example beam prediction NN 300 in accordance with aspects of the present disclosure. The NN 300, which may be the DNN 220 or another AI/ML model, includes an input layer 320, which receives data samples 310 (e.g., a training data set), hidden layers 330 (e.g., neural layers), and an output layer 340, which outputs a beam prediction index 350. Between the different layers are LN layers 325, which, as described herein, adapt and/or change statistical distributions of data samples between layers. The NN 300, therefore, may include an input layer, an output layer, and hidden layers, such as neural layers (e.g., hidden layers 330) and LN layers (e.g., LN layers 325).

The LN layers 325 perform layer normalization (e.g., on received input samples). Layer normalization may be defined as follows:

$${\hat{x}}_{i} = \frac{{x}_{i} - {μ}_{i}}{{σ}_{i}}$$

$${μ}_{i} = \frac{1}{\vert {𝒮}_{𝒾} \vert} {\sum }_{j ∈ {𝒮}_{𝒾}} {x}_{j}$$

$${σ}_{i} = \sqrt{\frac{1}{\vert {𝒮}_{𝒾} \vert} {\sum }_{j ∈ {𝒮}_{𝒾}} {( {x}_{j} - {μ}_{i} )}^{2} + ϵ}$$

where the set [symbol] is defined as [symbol] ={j|j_{B}=i_{B}}, with i_{B} (and j_{B}) denoting the sub-index of i (and j) along the B-axis (e.g., batch axis). Here, | [symbol] ᵢ| is the cardinality of [symbol] ᵢ and ϵ is a small positive value. Thus, the LN layers 325 compute a mean μ and standard deviation σ along the (C, H, W) axes for each data sample.

Then, \hat{x}ᵢ is transformed into LN (xᵢ)=γᵢ\hat{x}ᵢ+βᵢ, where γᵢ and βᵢ are learnable/trainable parameters, indexed by i_{C}. Note that, the multiplication of \hat{x}ᵢ with γᵢ is element wise multiplication and the addition of βᵢ is also element wise addition. Thus, γᵢ and βᵢ each have the same length as that of xᵢ. Essentially, the LN layers 325 normalize input samples in all neurons in a same layer for each data sample. Also, all elements of γᵢ will have the same value and all elements of βᵢ will have the same values. The parameter γᵢ is a learnable scale parameter and the parameter βᵢ is a learnable shift parameter for feature i. These two parameters are affine parameters of the LN layers 325. Further, the i^{th} LN layer has its learnable/trainable parameters as γᵢ, βᵢ, and a length of γᵢ, and βᵢ, is equal to the length of feature xᵢ.

A DNN (e.g., the DNN 220) may have an Nₙₒᵣₘ number of LN layers 325, denoted by [symbol] ₁, . . . , [symbol] Nₙₒᵣₘ. Let θ_{A} denote a set of all the learnable/trainable parameters of all the LN layers 325 in the NN 300 (e.g., the NN f_{θ}). Note that θ_{A} is a subset of θ (i.e., θ_{A}⊂θ) and θ denotes the set of all learnable/trainable parameters of NN f_{θ}. When each of the LN layers 325 in the NN f_{θ} performs layer normalization, for LN layers [symbol] ₁, . . . , [symbol] Nₙₒᵣₘ, the set of learnable/trainable parameters is given by θ_{A}={γ_{j,i}, β_{j,i}}, j=1, . . . , Nₙₒᵣₘ, i=1, . . . , Fⱼ, where Fⱼ is the total number of features at the input of the normalization layer [symbol] ⱼ.

The NN 300 may be trained using a labeled training data set [symbol] (e.g., via supervised learning/training, semi-supervised learning, self-supervised learning, unsupervised learning, and so on). For example, supervised learning/training of an NN f_{θ}, with θ={θ₁, θ₂, . . . , θ_{N}} as its learnable/trainable parameters may include selecting an architecture/structure of the network (e.g., a number of layers, how the layers are connected, and so on), such as convolutional NNs (CNNs), recurrent NNs (RNNs), long short-term memory (LSTM) NNs, and so on. Once the architecture/structure is selected, optimal values of learnable/trainable parameters by minimizing a loss function [symbol] over a training data set are determined.

As described herein, the NN 300 includes LN layers 325, which are placed in between the other layers of the NN 300. For example, the NN 300 includes the 325 LN layer between every pair of regular, non-normalization, neural layers (e.g., the hidden layers 330). The NN 300 depicts, as an example, a four-layer NN, with one input layer (e.g., the input layer 320), one output layer (e.g., the output layer 340) and two hidden layers (e.g., the hidden layers 330).

The LN layers 325 are placed or positioned between the input layer 320 and the first hidden layer 330, between the first hidden layer 330 and the second hidden layer 330, and between the second hidden layer 330 and the output layer 340. Thus, there are three LN layers 325 in the depicted four-layer NN, and an NN having a total number of N_{L} layers, with one LN layer 325 between every pair of neural layers, there are

$${N}_{n o r m} = \frac{{N}_{L} + 1}{2} - 1$$

number of LN layers 325.

The NN 300, or f_{θ} includes one LN layer 325 between every pair of other, regular (non-normalization) neural layers (e.g., the hidden layers 330), where θ={θ₁, θ₂, . . . , θ_{N}} represents the learnable parameters of the entire NN (e.g., the learnable parameters of the LN layers 325 and the hidden layers 330). The NN 300 may be trained through supervised learning by minimizing a loss function over the labeled training data set (e.g., the data samples 310). For example, the set of optimal parameters θ={θ₁, θ₂, . . . , θ_{N}} are determined by solving the following problem through a chosen/appropriate optimization algorithm (e.g., stochastic gradient descent (SGD), adaptive moment estimation (ADAM), and so on), where

$$θ = {min}_{\tilde{θ} ∈ {ℝ}^{N}} ℒ ( \tilde{θ} , {𝒟}_{tr} ) .$$

In some cases, the NN 300 functions to map a set of M′ beam measurements into one of M available beams, where the NN 300 is expressed as f_{θ}: [symbol] ^{M′}→ [symbol] , where θ={θ₁, θ₂, . . . , θ_{N}} denotes the set of all the learnable/trainable parameters/weights of the underlying NN.

The NN 300 may be probabilistic, as it generates a probability distribution over the predictions, conditioned on the input data samples 310 and parameterized by θ, where a conditional distribution is differentiable in θ. Thus, the NN 300, which is a beam prediction AI/ML model, trains on one or more source domains and generates a probability distribution P(y|x; θ) that is differentiable in θ. The prediction y is a best beam out of M beams. Hence, y is a discrete variable with y∈{1, . . . , M} and P(y|x; θ) is the probability that y is the predicted label for x under the model parameters θ. Thus, P(y|xᵢ; θ) is the probability that yⱼ is the best beam for the given set of beam measurements xᵢ, as per the prediction/inference made by the NN 300 with θ as its model parameters. Note that

$${\sum }_{c = 1}^{M} P ( {y}_{c} \vert {x}_{i} ; θ ) = 1 ,$$

or, equivalently, [symbol] P(y_{c}|xᵢ; θ)=1, where [symbol] ={1, . . . , M}.

As described herein, the NN 300 includes one or more LN layers 325, with each LN layer having a set of scale parameters and a set of shift parameters (e.g., collectively denoted as affine parameters). For example, the NN 300 may have N_{L} number of LN layers 325. For a j^{th} normalization layer, where j∈{1, . . . , N_{L}}, the j^{th} normalization layer has Fⱼ number of learnable/trainable scale parameters γ_{j,1}, . . . , γ_{j,F}_{ⱼ} and Fⱼ number of learnable/trainable shift parameters β_{j,1}, . . . , β_{j,F}_{ⱼ}, where Fⱼ is a total number of features at the j^{th} normalization layer input. Each γ_{j,i}, β_{j,i}, i=1, . . . , Fⱼ, includes an Lⱼ number of scalar parameters (e.g., γ_{j,i}={γ_{j,i,1}, γ_{j,i,2} . . . , γ_{j,i,L}_{ⱼ}} and β_{j,i}={β_{j,i,1}, β_{j,i,2} . . . , β_{j,i,L}_{ⱼ}} for i=1, . . . , Fⱼ) where Lⱼ is the length of the feature vector at the input of the j^{th} normalization layer, or, equivalently, a number of neurons in the j^{th} normalization layer.

However, for layer normalization, γ_{j,i,1}=γ_{j,i,2}= . . . =γ_{j,i,L}_{ⱼ} and β_{j,i,1}=β_{j,i,2}= . . . =β_{j,i,L}_{ⱼ}. Thus, there are Fⱼ number of learnable/trainable scale parameters γ_{j,1}, . . . , γ_{j,F}_{ⱼ} and the Fⱼ number of learnable/trainable shift parameters β_{j,1}, . . . , β_{j,F}_{ⱼ}, where Fⱼ is the total number of features at the j^{th} normalization layer input. Again, as described herein, the scale and shift parameters may be affine parameters of the LN layers 325. Further, let θ_{A} denote a set of the affine parameters of all the LN layers 325 in the NN 300, where

$${θ}_{A} = {\{ {γ}_{j , 1} , {γ}_{j , {F}_{j}} , {β}_{j , 1} , … , {β}_{j , {F}_{j}} \}}_{j = 1}^{{N}_{L}} .$$

θ_{A} may be a subset of θ (i.e., θ_{A}⊂θ) as θ denotes the set of all learnable/trainable parameters of the NN 300.

As described herein, the NN 300 (e.g., the DNN 220) may be adapted, modified, or optimized by adapting weights of the LN layers 325, such as by modifying θ_{A}, the set of affine parameters of the LN layers 325. Thus, in some cases, other parameters of the NN 300 (e.g., parameters/weights associated with the hidden layers 330) are unchanged or otherwise not adapted. For example, the NN 300 may be adapted to an unseen target domain with a few unlabeled samples from the target domain, where the target domain has a different distribution than one or more source domains over which the NN 300 is or was trained.

In some cases, the first node 205 (e.g., the NE 102, such as the gNB) triggers the adaptation of the NN 300 (e.g., the DNN 220). In other cases, the second node 215 may trigger the adaptation of the NN 300 and/or other network nodes (e.g., nodes associated with life cycle management of AI/ML models deployed by a wireless communications system may trigger the adaptation.

The first node 205, the second node 215, and/or another node may trigger the adaptation of the NN 300, or otherwise determine to update the NN 300, in a variety of ways. For example, the first node 205, the second node 215, and/or another node may determine to update the NN 300 based on information that indicates periodic time intervals for updating the NN model (e.g., the NN model is updated periodically in set intervals), based on receiving an indication to update the NN model from another node (e.g., a transmitting node), based on receiving a configuration associated with updating the NN model (e.g., from another node), based on information that indicates certain conditions of a communications network that supports the nodes, based on determining a quality metric for a functionality of the NN 300 (e.g., the model is accurately predicting the optimal beam over a threshold percentage of instances), and so on.

The second node 215, acting as a decoder, may capture, access, or otherwise utilize a set of data samples from a target domain, such as unlabeled data samples (e.g., data samples with unknown labels or target attributes). The second node 215, therefore, accesses or utilizes a few input samples

$${x}^{t} = \{ {x}_{1}^{t} , {x}_{2}^{t} , … , {x}_{n}^{t} \}$$

from the target domain, where each

$${x}_{i}^{t}$$

is a set of M′ beam measurements from the target domain (e.g., a domain associated with the NE 102). As described herein, the second node 215 may not know a best beam for each set of beam measurements (e.g., does not have information identifying corresponding labels yᵢ, i=1, . . . , n, for the input samples

$${x}_{i}^{t} ,$$

i=1, . . . , n)).

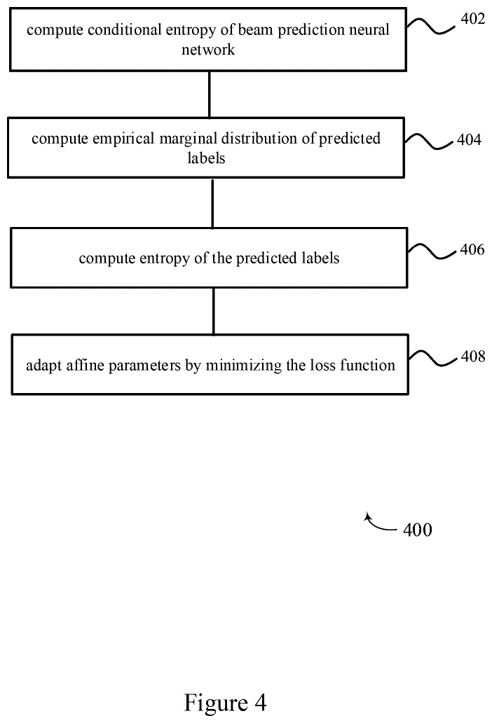

FIG. 4 illustrates a flowchart of a method 400 for adapting a beam prediction NN in accordance with aspects of the present disclosure. For example, the method 400 may adapt the f_{θ} to the target domain with n unlabeled samples

$${x}_{i}^{t} ,$$

i=1, . . . , n, from the target domain, as follows.

As described herein, θ is the set of all the parameters of the NN 300 and θ_{A} is the set of affine parameters of all the LN layers 325 of the NN 300, where θ_{A}=0. Thus, all the parameters in the set {θ\θ_{A}}, such as all the parameters in the set θ, except those parameters that belong to the set θ_{A}, are fixed (e.g., remain unchanged), and only the parameters in the set θ_{A} are adapted/adjusted to the target domain. The adaptation process, therefore, in a backward pass, adapts the affine parameters of all the LN layers 325, using the gradient of the loss function, as described herein. For example, a mapping of f_{θ} produces a conditional distribution P(y|x; θ) that is differentiable in θ. The method computes

$$P ( y \vert {x}_{i}^{t} ; θ )$$

for i=1, . . . , n.

At 402, the method 400 computes a conditional entropy of the beam prediction NN (e.g., the NN 300). For example, the method 400 computes the conditional entropy given n input data samples x^{t}:

$$H ( P ( y \vert {x}^{t} ; θ ) ) = {\sum }_{i = 1}^{n} P ( {x}_{i}^{t} ) H ( P ( y \vert {x}_{i}^{t} ; θ ) )$$

where P(x) is the probability distribution of the input data samples for the NN 300. In some cases, the probability distribution of the input data samples may be available for the NN 300 or may be provided to the node/entity performing the model selection. For example, the probability distribution may be based on a set of training data samples used to train the model. Assuming the input data samples are equally likely, the conditional entropy may be given as the average of the entropy of the AI/ML model predictions (y) given the n input data samples x^{t}, or

$$H ( P ( y \vert {x}^{t} ; θ ) ) = \frac{1}{n} {\sum }_{i = 1}^{n} H ( P ( y \vert {x}_{i}^{t} ; θ ) ) = - \frac{1}{n} {\sum }_{i = 1}^{n} {\sum }_{{y}_{c} ∈ ℳ} P ( {y}_{c} \vert {x}_{i}^{t} ; θ ) log P ( {y}_{c} \vert {x}_{i}^{t} ; θ )$$

In some cases, the logarithm (log) may be a base natural logarithm, or a base-2 log. Further, adapting the parameters to minimize the conditional entropy

$$\frac{1}{n} {\sum }_{i = 1}^{n} H ( P ( y \vert {x}_{i}^{t} ; θ ) )$$

may assist in improving the confidence in individual predictions and/or enable the model to generate more confident predictions. However, in some cases, considering only the conditional entropy minimization can lead to degenerate solutions where the adapted model puts all the probability mass on a single or very few labels, predicting a single or very few best beams for all instances of beam measurements.

At 404, the method 400 computes an empirical marginal distribution of predicted labels. For example, the method 400 computes the empirical marginal distribution of predicted labels using:

$$\tilde{P} ( y ; θ ) = \frac{1}{n} {\sum }_{i = 1}^{n} P ( y \vert {x}_{i}^{t} ; θ )$$

In some cases, the computed distribution \tilde{P}(y; θ) is an approximation of P(y; θ), which is the true marginal distribution of y. (e.g., the superscript tilde indicating the approximation).

At 406, the method 400 computes the entropy of the predicted labels. For example, the method 400 may compute the entropy of the predicted labels, by:

$$H ( \tilde{P} ( y ; θ ) ) = - {\sum }_{y ∈ ℳ} \tilde{P} ( y ; θ ) log \tilde{P} ( y ; θ )$$

In some cases, a higher value of H(\tilde{P}(y; θ)) ensures balance across label prediction, or that the marginal distribution of the predicted labels is close to a unform distribution, which is a desired quality with a reasonable number of data samples

$${x}_{i}^{t} ,$$

i=1, . . . , n. The method 400 may then set a loss function to:

$$ℒ ( θ ; {x}^{t} ) = {w}_{1} \frac{1}{n} {\sum }_{i = 1}^{n} H ( P ( y \vert {x}_{i}^{t} ; θ ) ) - {w}_{2} H ( \tilde{P} ( y ; θ ) )$$

where w₁ and w₂ are the weights (e.g., the importance) assigned to each term in the loss function and are considered hyper-parameters with 0<w₁, w₂≥1. When

$${w}_{1} = {w}_{2} = 1 , ℒ ( θ ; {x}^{t} ) = - I ( {x}^{t} ; y ) ,$$

where I(x^{t}; y) denotes the mutual information between x^{t} and y, the input and output of the NN 300.

In some cases, because the conditional distribution P(y|x; θ) produced by the mapping f_{θ} is differentiable in θ, the loss function is differentiable in θ_{A}. Hence, loss function minimization can be performed through gradient based methods. However, instead of straightforward minimization of the entropy, the method 400 minimizes the entropy as well as the sharpness of the entropy, as described herein.

At 408, the method 400 adapts affine parameters by minimizing the loss function. For example, the method 400 minimizes the loss function to realize:

$${θ}_{A}^{t} = {min}_{{θ}_{A}} ℒ ( θ ; {x}^{t} )$$

where

$${θ}_{A}^{t}$$

denotes the adapted/modified attine parameters of all of the LN layers 325 of the beam prediction NN 300. Note that θ={θ₁, θ₂, . . . , θ_{N}} and the adapted beam prediction model is denoted by f_{θ}_{^{t}}, where θ^{t} denotes the adapted parameters of the entire NN 300. The method 400 only adapts θ_{A} (e.g., the affine parameters of the LN layers 325 of the NN 300) to

$${θ}_{A}^{t}$$

and does not change {θ\θ_{A}}, or the remaining parameters of the NN 300). Thus, the final adapted model parameters, denoted by θ^{t}, are

$${θ}^{t} = {θ}_{A}^{t} ⋃ \{ θ ∖ {θ}_{A} \} .$$

The following is an example implementation of the method 400, where a beam prediction DNN model is adapted via its LN layers using unlabeled samples. The input is a beam prediction DNN model f_{θ} and unlabeled samples

$${x}^{t} = \{ {x}_{1}^{t} , {x}_{2}^{t} , … , {x}_{n}^{t} \}$$

from a target domain. The output is an adapted beam prediction DNN model f_{θ}_{^{t}}.

In step 1, a set θ_{A} is formed comprising of all the affine parameters of all the LN layers of the beam prediction DNN, such that θ=θ_{A}∪{θ\θ_{A}}.

In step 2, x^{t} and f_{θ} are used to determine

$$P ( y \vert {x}_{i}^{t} ; θ )$$

for i=1, . . . , n.

In step 3, the conditional entropy is computed, as follows:

$$H ( P ( y \vert {x}^{t} ; θ ) ) = {\sum }_{i = 1}^{n} P ( {x}_{i}^{t} ) H ( P ( y \vert {x}_{i}^{t} ; θ ) )$$

Next, in step 4, H(\tilde{P}(y; θ))=− [symbol] \tilde{P}(y; θ) log \tilde{P}(y; θ) is computed, where

$$\tilde{P} ( y ; θ ) = \frac{1}{n} {\sum }_{i = 1}^{n} P ( y \vert {x}_{i}^{t} ; θ ) .$$

In step 5, the loss function

$$ℒ ( θ ; {x}^{t} ) = \frac{1}{n} {\sum }_{i = 1}^{n} H ( P ( y \vert {x}_{i}^{t} ; θ ) ) - H ( \tilde{P} ( y ; θ ) ) ,$$

is computed.

In step 6, the adapted parameters

$${θ}_{A}^{t}$$

are determined, as

$${θ}_{A}^{t} == {min}_{{θ}_{A}} ℒ ( θ ; {x}^{t} ) .$$

In step 7, the adapted beam prediction DNN model parameters are given by

$${θ}^{t} = {θ}_{A}^{t} ⋃ \{ θ ∖ {θ}_{A} \} .$$

Thus, in various embodiments, an AI/ML model employed to perform beam prediction for a cell site (e.g., a base station, such as a gNB) may be adapted to specific parameters or characteristics associated with the cell site by adapting the parameters (e.g., the affine parameters) of the LN layers of the AI/ML model using target domain data samples. In doing so, a wireless communications system may employ the beam prediction AI/ML model to assist beam prediction procedures in a targeted and efficient manner, among other benefits, via an AI/ML model (e.g., a DNN) that is adapted or otherwise tailored to a specific cell site or scenario.

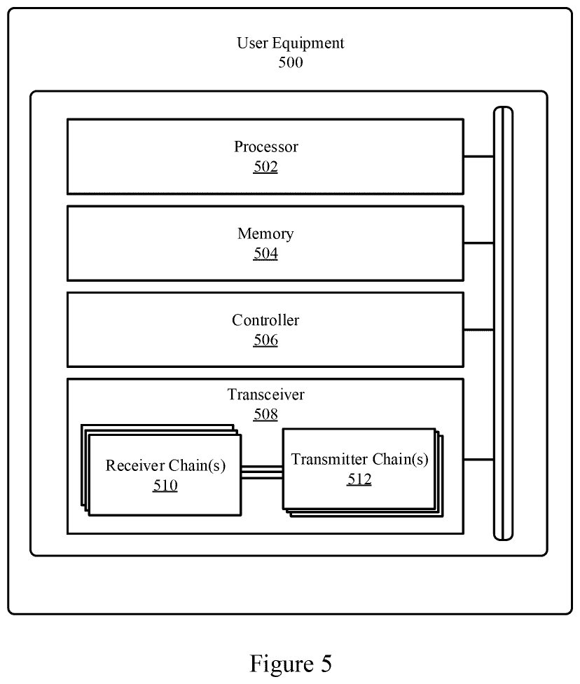

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein.

For example, the processor 502 may support wireless communication at the UE 500 in accordance with examples as disclosed herein. The UE 500 may be configured to support a means for determining an NN model for beam prediction, by computing a set of NN parameters associated with multiple neural layers of the NN model and computing a set of affine parameters associated with at least one LN layer of the NN model, and transmitting, to a second node, a set of model parameters that includes the set of NN parameters and the set of affine parameters.

As another example, the UE 500 may be configured to support a means for determining whether to update an NN model for beam prediction, wherein the NN model for beam prediction includes multiple neural layers, at least one LN layer, and a set of affine parameters associated with at least one LN layer, and updating the set of affine parameters based on a set of input data samples.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receive the signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

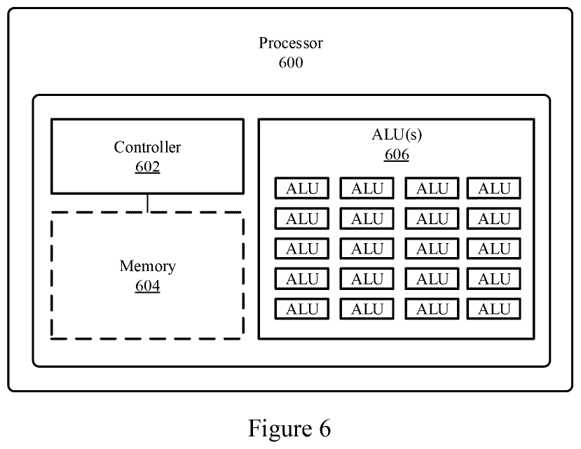

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. For example, the processor 600 may be configured to support a means for determining an NN model for beam prediction, by computing a set of NN parameters associated with multiple neural layers of the NN model and computing a set of affine parameters associated with at least one LN layer of the NN model, and transmitting, to a second node, a set of model parameters that includes the set of NN parameters and the set of affine parameters.

As another example, the processor 600 may be configured to support a means for determining whether to update an NN model for beam prediction, wherein the NN model for beam prediction includes multiple neural layers, at least one LN layer, and a set of affine parameters associated with at least one LN layer, and updating the set of affine parameters based on a set of input data samples.

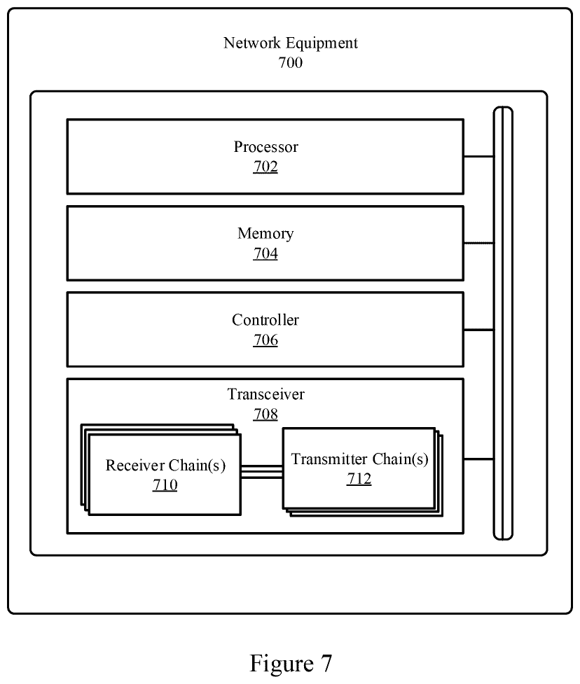

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704).

For example, the processor 702 may support wireless communication at the NE 700 in accordance with examples as disclosed herein. The NE 700 may be configured to support a means for determining an NN model for beam prediction, by computing a set of NN parameters associated with multiple neural layers of the NN model and computing a set of affine parameters associated with at least one LN layer of the NN model, and transmitting, to a second node, a set of model parameters that includes the set of NN parameters and the set of affine parameters.

As another example, the NE 700 may be configured to support a means for determining whether to update an NN model for beam prediction, wherein the NN model for beam prediction includes multiple neural layers, at least one LN layer, and a set of affine parameters associated with at least one LN layer and updating the set of affine parameters based on a set of input data samples.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receive the signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

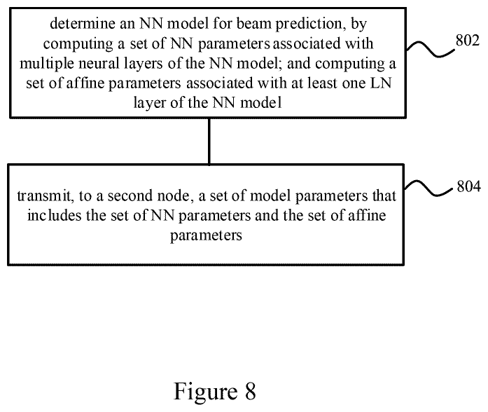

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include determining an NN model for beam prediction, by computing a set of NN parameters associated with multiple neural layers of the NN model and computing a set of affine parameters associated with at least one LN layer of the NN model. The operations of 802 may be performed in accordance with examples as described herein. In some implementations, aspects of the operations of 802 may be performed by an NE as described with reference to FIG. 7.

At 804, the method may include transmitting, to a second node, a set of model parameters that includes the set of NN parameters and the set of affine parameters. The operations of 804 may be performed in accordance with examples as described herein. In some implementations, aspects of the operations of 804 may be performed by an NE as described with reference to FIG. 7.

It should be noted that the method described herein describes a possible implementation, and that the operations and the steps may be rearranged or otherwise modified and that other implementations are possible.

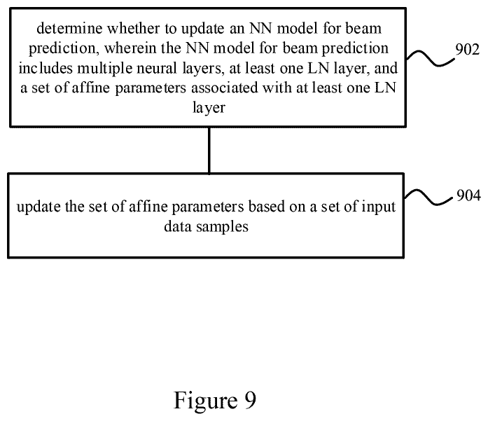

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include determining whether to update an NN model for beam prediction, wherein the NN model for beam prediction includes multiple neural layers, at least one LN layer, and a set of affine parameters associated with at least one LN layer. The operations of 902 may be performed in accordance with examples as described herein. In some implementations, aspects of the operations of 902 may be performed by a UE as described with reference to FIG. 5.

At 904, the method may include updating the set of affine parameters based on a set of input data samples. The operations of 904 may be performed in accordance with examples as described herein. In some implementations, aspects of the operations of 904 may be performed by a UE as described with reference to FIG. 5.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node for wireless communication, comprising:
at least one memory; and
at least one processor coupled with the at least one memory and configured to cause the first node to:
determine a neural network (NN) model for beam prediction, by:
computing a set of NN parameters associated with multiple neural layers of the NN model; and
computing a set of affine parameters associated with at least one layer normalization (LN) layer of the NN model; and
transmit, to a second node, a set of model parameters that includes the set of NN parameters and the set of affine parameters.

2. The first node of claim 1, wherein the set of affine parameters includes a set of scale parameters and a set of shift parameters for the at least one LN layer.

3. The first node of claim 1, wherein the NN model is based on a set of data samples that includes unlabeled data samples, labeled data samples, or a combination of unlabeled data samples and labeled data samples.

4. The first node of claim 3, wherein the at least one processor is further configured to cause the first node to determine the set of data samples.

5. The first node of claim 3, wherein the at least one processor is further configured to cause the first node to receive the set of data samples from another node.

6. The first node of claim 3, wherein the at least one processor is configured to cause the first node to determine the NN model for beam prediction by:
computing a global set of parameters, which includes the set of NN parameters and the set of affine parameters, via a learning algorithm that is based on the set of data samples.

7. A second node for wireless communication, comprising:
at least one memory; and
at least one processor coupled with the at least one memory and configured to cause the second node to:
determine whether to update a neural network (NN) model for beam prediction,
wherein the NN model for beam prediction includes:
multiple neural layers;
at least one layer normalization (LN) layer; and
a set of affine parameters associated with at least one LN layer; and
update the set of affine parameters based on a set of input data samples.

8. The second node of claim 7, wherein the at least one processor is further configured to cause the second node to determine the set of input data samples.

9. The second node of claim 7, wherein the at least one processor is further configured to cause the second node to receive the set of data samples from another node.

10. The second node of claim 7, wherein the at least one processor is configured to cause the second node to update the set of affine parameters by:
determining a first quantity associated with a measure of uncertainty in an output of the NN model resulting from the set of input data samples;
determining a second quantity associated with a remaining uncertainty in the output of the NN model resulting from the set of input data samples;
determining a weighted first quantity for the first quantity and a weighted second quantity for the second quantity; and
determining the set of affine parameters by minimizing a difference between the second weighted quantity and the first weighted quantity.

11. The second node of claim 10, wherein the measure of uncertainty in the output of the NN model is a measure of entropy of the output.

12. The second node of claim 10, wherein the measure of remaining uncertainty in the output of the NN model is a measure of conditional entropy in the output.

13. The second node of claim 10, wherein the weighted first quantity and the weighted second quantity are based on weights having values between 0 and 1, inclusive.

14. The second node of claim 7, wherein the at least one processor is configured to cause the second node to determine to update the NN model based on information that indicates periodic time intervals for updating the NN model.

15. The second node of claim 7, wherein the at least one processor is configured to cause the second node to determine to update the NN model based on receiving an indication to update the NN model from a first node.

16. The second node of claim 7, wherein the at least one processor is configured to cause the second node to determine to update the NN model based on receiving a configuration associated with updating the NN model from a first node.

17. The second node of claim 7, wherein the at least one processor is configured to cause the second node to determine to update the NN model based on information that indicates certain conditions of a communications network that includes the second node.

18. The second node of claim 7, wherein the at least one processor is configured to cause the second node to determine to update the NN model based on determining a quality metric for a functionality of the NN model.

19. A method performed by a first node of a communications network, the method comprising:
determining a neural network (NN) model for beam prediction, by:
computing a set of NN parameters associated with multiple neural layers of the NN model; and
computing a set of affine parameters associated with at least one layer normalization (LN) layer of the NN model; and
transmitting, to a second node, a set of model parameters that includes the set of NN parameters and the set of affine parameters.

20. A processor for wireless communication, comprising:
at least one controller coupled with at least one memory and configured to cause the processor to:
determine whether to update a neural network (NN) model for beam prediction,
wherein the NN model for beam prediction includes:
multiple neural layers;
at least one layer normalization (LN) layer; and
a set of affine parameters associated with at least one LN layer; and
update the set of affine parameters based on a set of input data samples.
